(19) United States
(12) Patent Application Publication
(10) Pub. No.: US 2010/0150043 A1
(43) Pub. Date: Jun. 17, 2010

(54) ASYNCHRONOUS MAC PROTOCOL BASED SENSOR NODE AND DATA TRANSMITTING AND RECEIVING METHOD THROUGH THE SAME

(75) Inventors: Se-han KIM, Daejeon-si (KR); Nae-soo Kim, Daejeon-si (KR); Cheol-sig Pyo, Daejeon-si (KR); Eun-sang Choo, Anyang-si (KR); Byung-kwan Cho, Anyang-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/630,406

(22) Filed: Dec. 3, 2009

(30) Foreign Application Priority Data
Dec. 17, 2008 (KR) 10-2008-0128716

(51) Int. Cl. G08C 17/02

(52) U.S. Cl. 370/311

(57) ABSTRACT

Disclosed is an asynchronous MAC based sensor node using a Wake-Up RF. The sensor node includes a main transceiver to transmit/receive data, a Wake-Up transceiver to transit a state of the sensor node; and a micro-control unit, which transmits a Wake-Up frame to at least one receiving node through the Wake-Up transceiver such that the receiving node is activated from an inactive state into an active state and transmits data to the activated receiving node through the main transceiver. The asynchronous MAC based sensor node reduces unnecessary power consumption, hop-by-hop delay, and overhead required for timing synchronization, thereby implementing an effective sensor

### CROSS-REFERENCE TO RELATED APPLICATION

This application claims the benefit under 35 U.S.C. §119(a) of Korean Patent Application No. 10-2008-0128716, filed on Dec. 17, 2008, the disclosure of which is incorporated by reference in its entirety for all purposes.

### BACKGROUND

1. Field

The following description relates to a ubiquitous sensor network, and more particularly, to a media access control protocol used when constituting a ubiquitous sensor network.

2. Description of the Related Art

A ubiquitous sensor network (USN) is a network system, which is intended to constitute a wireless sensor network through a sensor node, which includes a sensor used for detecting awareness information about objects or surrounding environment, and to transmit information, which is input through various sensors, to external entities in real time, thereby processing and managing the information. The USN provides every object with a computing function and a communication function, thereby realizing a communication environment independent from networks, devices or services at any time and place.

Different from a general wireless network used to transmit data, the USN is intended to achieve reduced power consumption, smaller size and reduced cost, and operates using batteries. Since the USN adopts a communication scheme based on batteries, communication needs to be performed during a preset communication period, for example, an active period, and the power of a wireless transceiver needs to be turned off during a non-communication period corresponding to an inactive period using a minimum amount of power.

In addition, a medium access control (MAC) protocol for a synchronous sensor network such as zigbee/IEEE802. 15. 4 Low-Rate WPAN (wireless personal area network) is configured to allow each sensor node to be turned on/off depending on inactive period/active period, thereby reducing power required for the sensor node. Accordingly, the total power consumption of the sensor network is minimized. However, such a synchronous sensor network MAC protocol has problems of unnecessary power consumption, a hop-by-hop delay, and overhead required for timing synchronization.

### SUMMARY

Accordingly, in one aspect, there is provided a ubiquitous sensor network, capable of reducing data transmission delay, overhead due to timing synchronization and extreme battery is consumption.

In one general aspect, there is provided a method of transmitting data in a sensor node for constituting a sensor network. The method is performed as follows. A Wake-Up frame is transmitted to at least one receiving node which is in an inactive state, thereby activating the receiving node. After that, data is transmitted to the activated receiving node. The transmitting of the Wake-Up frame is performed by a Wake-Up transceiver that is provided additionally in the sensor node including a main transceiver.

The transmitting of the Wake-Up frame includes supplying power to the Wake-Up transceiver which is in a power off state; and transmitting the Wake-Up frame to the receiving node through the Wake-Up transceiver, to which power has been supplied.

The transmitting of the wake-up frame to the receiving node includes supplying power to the main transceiver which is in a power off state; receiving a response packet in response to the Wake-Up packet from the receiving node through the main transceiver to which power has been supplied; and transmitting the data to the receiving node, which has transmitted the response packet, through the main transceiver.

The transmitting of the data to the receiving node further comprises transmitting a response confirmation packet to the receiving node which has transmitted the response packet; and wherein the transmitting of the data through the main transceiver is performed after the response confirmation packet is transmitted.

In another general aspect, there is provided a method of receiving data transmitted from a sending node in a sensor node constituting a sensor network. The method is performed as follows. An inactive state transits to an active state by receiving a Wake-Up frame transmitted from the sending node. A response packet is transmitted in response to the Wake-Up frame to the sending node after the transition into the active state. Then, data is received from the is sending node which has received the response packet. The Wake-Up frame is received through a Wake-Up transceiver that is provided additionally in the sensor node including a main transceiver.

The transition of the sensor node to the active state includes when receiving the Wake-Up frame, at the Wake-Up transceiver, which operates in the inactive state, outputting a Wake-Up interrupt signal to a micro control unit, which operates in a sleep mode; and at the micro-control unit, which has transited to an active mode by receiving the Wake-Up interrupt signal, supplying power to the main transceiver.

The transiting of the sensor node into the active state further includes cutting off power supplied to the Wake-Up transceiver.

In another general aspect, there is provided a sending sensor node. The sending sensor node includes a main transceiver to transmit/receive data; a Wake-Up transceiver to transit a state of the sending sensor node; and a micro-control unit, which transmits a Wake-Up frame to at least one receiving node through the Wake-Up transceiver such that the receiving node is activated from an inactive state into an active state, and transmits data to the activated receiving node through the main transceiver.

In another general aspect, there is provided a receiving sensor node. The receiving sensor node includes a main transceiver to transmit/receive data; a Wake-Up transceiver which operates in an inactive state to transit a state of the receiving sensor node; and a micro-control unit. When a Wake-Up frame is transmitted from a sending node to the Wake-Up transceiver, the micro-control unit transits from an inactive state to an active state such that the data is received from the sending node through the main transceiver which operates in an active state.

According to the present invention, a sending node wakes up a receiving node only during a data transmission period, and thus unnecessary power consumption caused by a periodical operation of active/inactive modes is reduced, a hop-by-hop delay is prevented and the overhead required for synchronization is reduced. Accordingly, the reliability of data transmission is improved.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a view illustrating a ubiquitous sensor network configured using an IEEE801.15.4 based synchronous MAC;

FIG. 2 is a view illustrating an operation of the synchronous MAC;

FIG. 3 is a view illustrating an operation of an exemplary asynchronous MAC protocol using a Wake-Up RF;

FIG. 4 is a block diagram illustrating exemplary sensor nodes;

FIG. 5 is a flowchart showing an operation of an exemplary Wake-Up MAC;

FIG. 6 is a view illustrating a Broadcast Wake-Up in which a sending node wakes up all nearby sensor nodes;

FIG. 7 is a flowchart showing a process of the Broadcast Wake-Up;

FIG. 8 is a view illustrating a Multicast Wake-Up in which a sending node wakes up nearby sensor nodes in a group;

FIG. 9 is a flowchart showing a process of the Multicast Wake-Up;

FIG. 10 is a view illustrating a Unicast Wake-Up in which a sending node wakes up a single sensor node;

FIG. 11 is a flowchart showing a process of the Unicasat Wake-Up operation;

FIG. 12 is a view illustrating a Wake-Up Packet through which a sending node wakes up is a receiving node;

FIG. 13 is a view illustrating a Wake-Up Ack Packet through which a receiving node which has received a Wake-Up Packet responds to a sending node; and

FIG. 14 is a view illustrating a Wake-Up Confirm Packet transmitted from a sending node, which has received a Wake-Up Ack Packet, to a receiving node.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

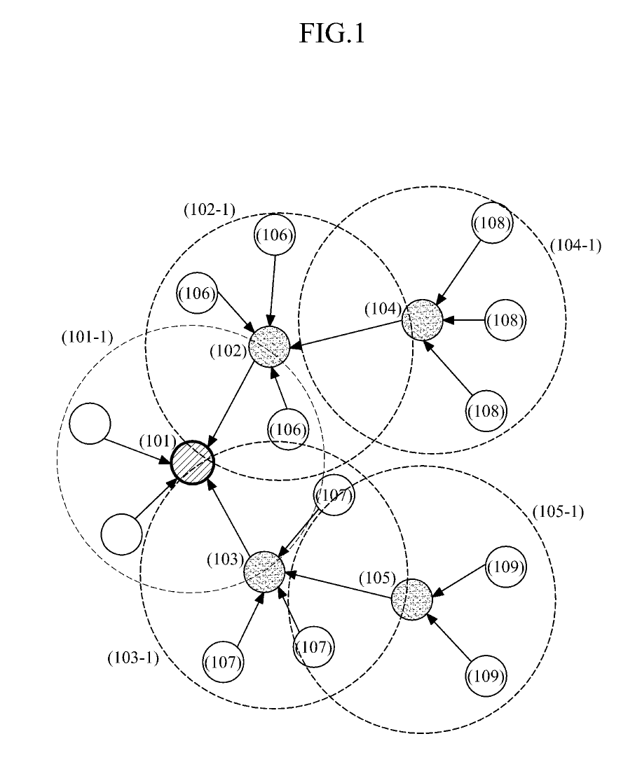

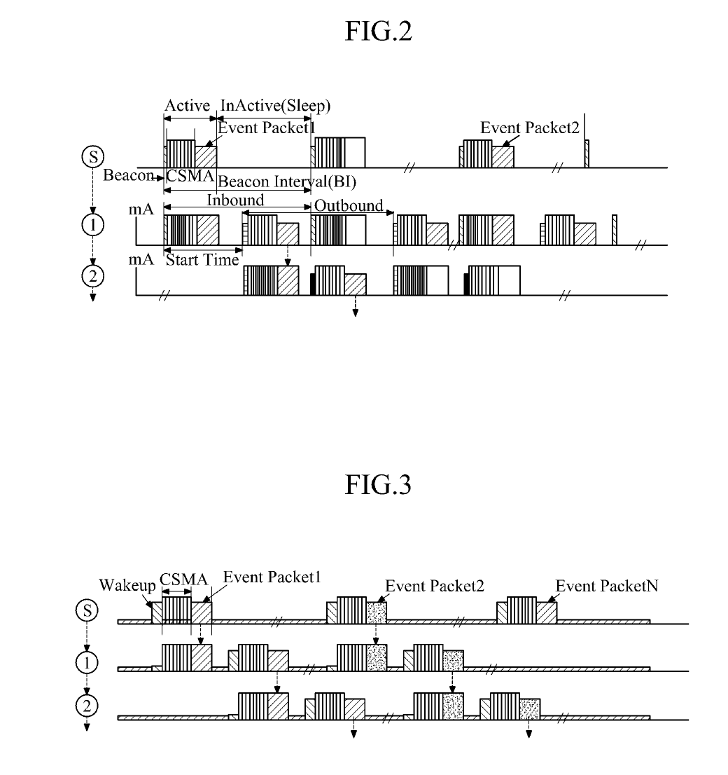

FIG. 1 is a view illustrating a ubiquitous sensor network configured using an IEEE801.15.4 based synchronous MAC, and FIG. 2 is a view illustrating an operation of the synchronous MAC.

A first PAN (personal area network) coordinator 101 is an exemplary node constituting a sensor network, and manages the use of radio resources of the sensor network while interoperating with an external network. Coordinators 102, 103, 104 and 105 collect information through a sensor and routs sensor data collected by device nodes (or end nodes) 106, 107, 108 and 109. Dotted lines 101-1, 102-1, 103-1, 104-1 and 105-1 shown in FIG. 1 represent a transmission range of waves among the first PAN coordinator 101 and other is coordinators 102, 103, 104 and 105.

The sensor network is configured through a logical association between parent nodes and child nodes. As shown in FIG. 1, the node 101 is a parent of the node 102, the node 102 is a parent of the node 104, and the node 104 is a parent of the node 108. Information collected from the node 108 is transmitted to the node 101 through the nodes 104 and 102 serving as the parents of the node 108. The node 101 finally transmits the collected information to an external network. The association between the parent nodes and child nodes achieves a logical connection, and data is transmitted only through the associated nodes. For example, even if both of the node 102 and the node 104 are placed within the transmission range of the node 108, data of the node 108 is transmitted to the node 102 through the node 104.

As shown in FIG. 2, a MAC based on IEEE802.15.4 operates as shown in FIG. 2, thereby forming the above network. The MAC protocol is configured such that the sensor nodes maintain lowest power consumption and a normal power consumption corresponding to an inactive period and an active period, respectively, thereby minimizing power consumption of the entire sensor network. The configuration of the MAC protocol required for implementing the active/inactive periods is set up in the first PAN coordinator 101 such that the first PAN coordinator and other respective coordinators transmit a beacon packet to child nodes belonging to the respective coordinators, so that the nodes operate in synchronization with active/inactive periods specified in the beacon. However, the sensor nodes constituted through a periodic transmission of a beacon maintain active/inactive periods based on the transmission of the beacon.

In this regard, even when actual transmission of data is not performed, the sensor nodes need to operate in response to the active/inactive periods. In addition, the data transmission is possible only during the active period, and thus unnecessary power consumption is required and is a hop-by-hop delay is caused. Meanwhile, it is difficult to maintain accurate transmission timing using the beacon packet.

The present invention provides an asynchronous MAC protocol capable of performing a communication only when the data transmission is required by using a Wake-Up communication module. Accordingly, data transmission delay, overhead due to timing synchronization and battery consumption are reduced.

FIG. 3 is a view illustrating an operation of an exemplary asynchronous MAC protocol using a Wake-Up RF.

Even when a packet to be transmitted/received is not present, the conventional synchronous MAC periodically implements active/inactive states. However, the exemplary asynchronous MAC maintains an inactive state and maintains an active state only when the packet is transmitted. A sending sensor node wakes up a receiving sensor node, which normally maintains an inactive state having a low power level, by using a Wake-Up Packet. After the receiving sensor node has been activated, the sending sensor node transmits a data packet to the receiving sensor node. If the sending sensor node does not need to send packets, the receiving sensor node maintains an inactive state until a next event occurs.

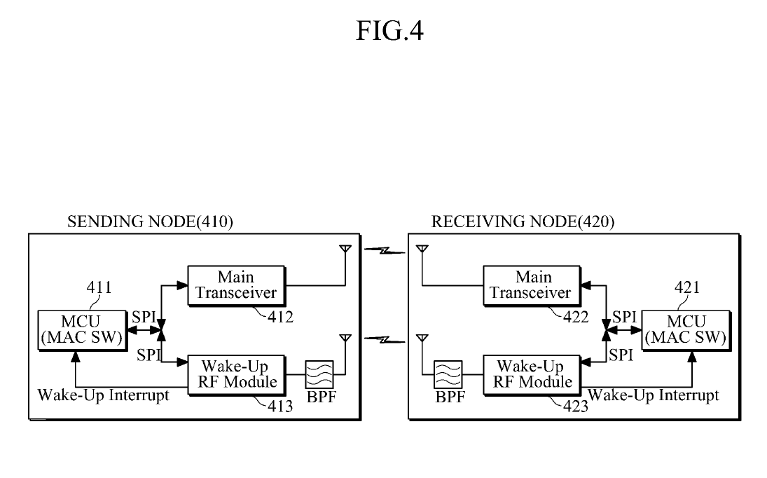

FIG. 4 is a block diagram illustrating exemplary sensor nodes.

The sensor node is classified into a sending node 410 and a receiving node 420 that are specified depending on whether data is transmitted or received. The sensor node includes micro-control units (MCU) 411 and 421 on which MAC software is mounted to process sensor data and control a wireless transceiver, main transceivers 412 and 422 for data transmission, and Wake-Up transceivers (hereinafter, referred to as a Wake-Up RF module) 413 and 423 used to wake up the sensor nodes which are in an inactive state.

The sending node 410 having a data packet to be transmitted operates in an active state and the receiving node 420 to receive the packet operates in an inactive state. The active state is represents a full power mode, in which the MCUs 411 and 421 are activated, and the main transceiver 412 maintains a power-on state. The inactive state represents a minimum power mode in which the MCU 421 operates in a sleep mode maintaining a minimum power level, the main transceiver 422 has a power-off state, and the Wake-Up RF module 423 maintains a power-on state having a low power level.

The sending node 410 transmits a Wake-Up frame to the receiving node 420 by using the Wake-Up RF module 413. The Wake-Up RF module 423 of the receiving node 420, which has received the Wake-Up frame, wakes up the MCU 421, which is in a low power level state, through a Wake-Up Interrupt. The woken MCU 421 turns on the main transceiver 422. Accordingly, the sending node 410 and the receiving node 420 are set into a state enabling data transmission/reception.

Meanwhile, the main transceiver and the Wake-Up RF module may use a chip or a module in common. In addition, if the main transceiver and the Wake-Up RF module use the same frequency, the main transceiver may share an antenna with the Wake-Up RF module. In addition, an interface of the Wake-Up RF module is realized based on an SPI (serial peripheral interface) communication scheme generally used in a conventional sensor node, thereby unifying a communication mode of the sensor node with a conventional sensor node.

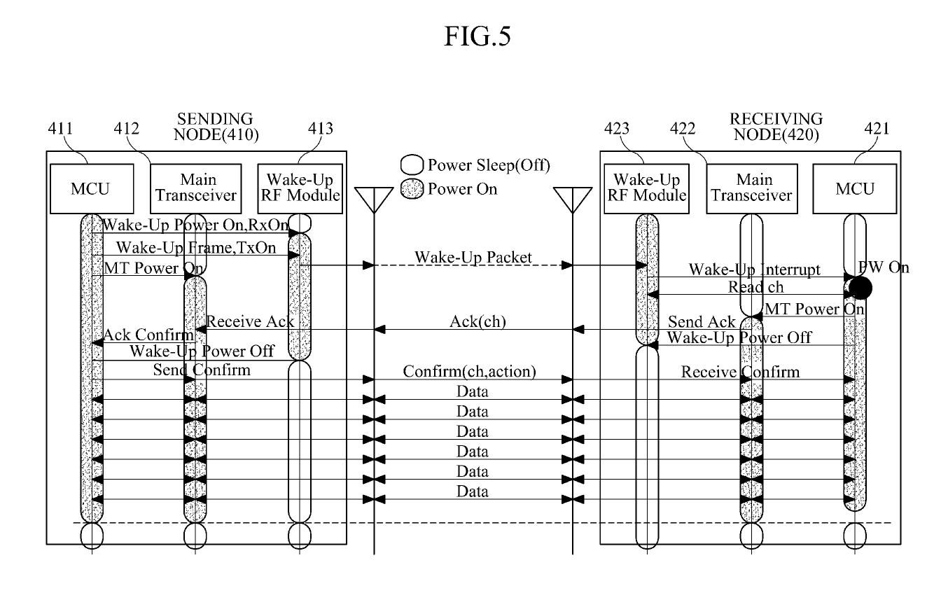

FIG. 5 is a flowchart showing an operation of an exemplary Wake-Up MAC.

The sending node 410 having data (for example, sensor data) to be transmitted turns on the Wake-Up RF module 413 to wake up the receiving node 420 which is in an inactive state. After that, the sending node mode 410 generates a Wake-Up frame and transmits the Wake-Up frame to the receiving node 420 through the Wake-Up RF module 413. Then, the sending node 410 turns on the main transceiver 412 to receive an Ack Packet from the receiving node 420.

In the receiving node 420 which is in an inactive state, if the Wake-Up RF module 423, which has received the Wake-Up frame, transmits a Wake-Up Interrupt to the MCU 421, then is the MCU 421 is activated. The activated MCU 421 transmits an Ack (Ch) to the sending node 410 through the main transceiver 422, thereby reporting that the receiving node 420 is woken up. Then, the Wake-Up RF module 423 is turned off.

The Wake-Up frame to be transmitted from the sending node 410 includes channel information available on the sending node 410 and address information of the receiving node 420. The MCU 421 of the receiving node 420 sends an Ack (Ch), which piggy-backs the channel information included in the Wake-Up frame. After the transmitting of the Ack (Ch), the receiving node 420 operates an Ack Timer before receiving a Confirm from the sending node 410. The MCU 411, which has received the Ack (Ch), transmits a Confirm frame to the receiving node 420 through the main transceiver 412, thereby confirming that the receiving node 420 is woken up. Only after the sending node 410 and the receiving node 420 are set into an active state, the sending node 410 can transmit data using various schemes. The sending node 410 transmits data using a data transmission scheme according to IEEE802. 15. 4. The receiving node 420 transits into an inactive state after maintaining the active state during a predetermined period based on information about activation/deactivation time durations which is contained in the confirmation frame.

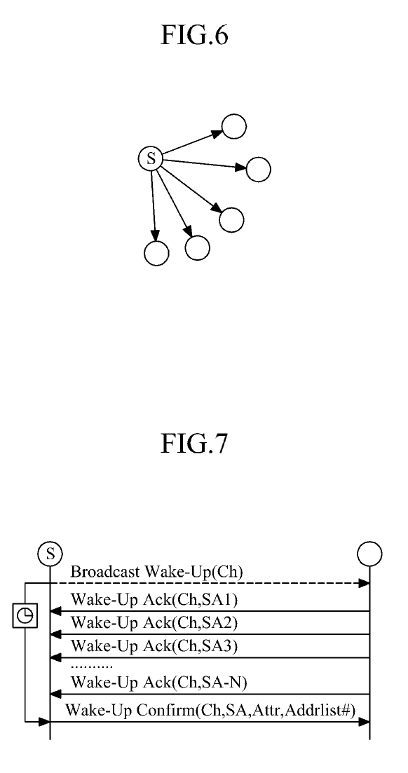

FIG. 6 is a view illustrating a Broadcast Wake-Up operation in which a sending node wakes up all nearby sensor nodes, and FIG. 7 is a flowchart showing a process of the Broadcast Wake-Up.

A sending node transmits a Broadcast Wake-Up (Ch) packet to nearby sensor nodes through a Wake-Up RF module, and sets a Broadcast Wake-Up wait time. During the Broadcast Wake-Up wait time, each of the sensor nodes which have received the Broadcast Wake-Up (Ch) packet transmits a Wake-Up Ack packet to the sending node. After the Broadcast Wake-Up wait time has lapsed, the sending node, which has received the Wake-Up Ack packets, transmits a Wake-Up Confirm packet to the sensor nodes, which have received the is Broadcast Wake-Up (Ch) packet, thereby checking a Wake-Up state of the sensor nodes.

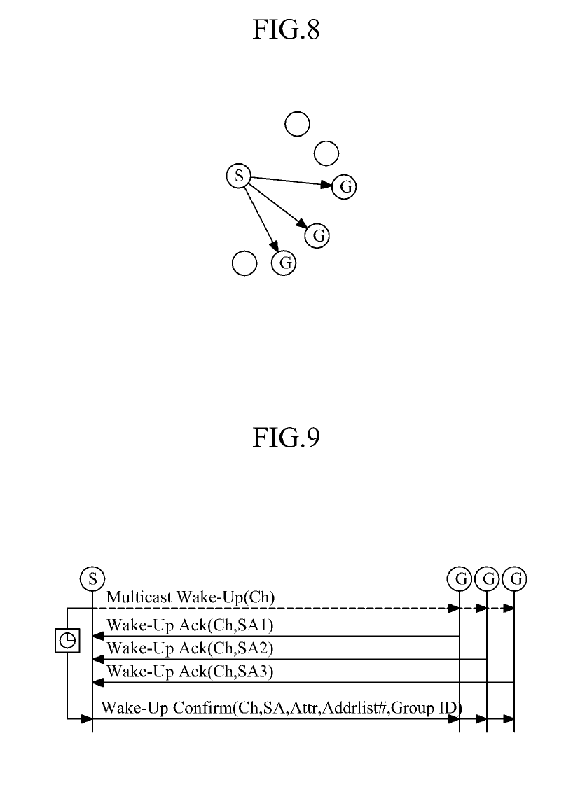

FIG. 8 is a view illustrating a Multicast Wake-Up in which a sending node wakes up nearby sensor nodes in a group, and FIG. 9 is a flowchart showing a process of the Multicast Wake-Up.

A sending node transmits a Multicast Wake-Up (Ch) packet to nearby sensor nodes in a group through a Wake-Up RF module, and sets a Multicast Wake-Up wait time. During the Multicast Wake-Up wait timer, each of the sensor nodes, which have received the Multicast Wake-Up (Ch) packet and have group IDs, transmits a Wake-Up Ack packet to the sending node. After the Multicast Wake-Up wait time has lapsed, the sending node, which has received the Wake-Up Ack packets, transmits a Wake-Up Confirm packet to the sensor nodes, which have received the Multicast Wake-Up (Ch) packet, thereby checking a Wake-Up state of the sensor nodes.

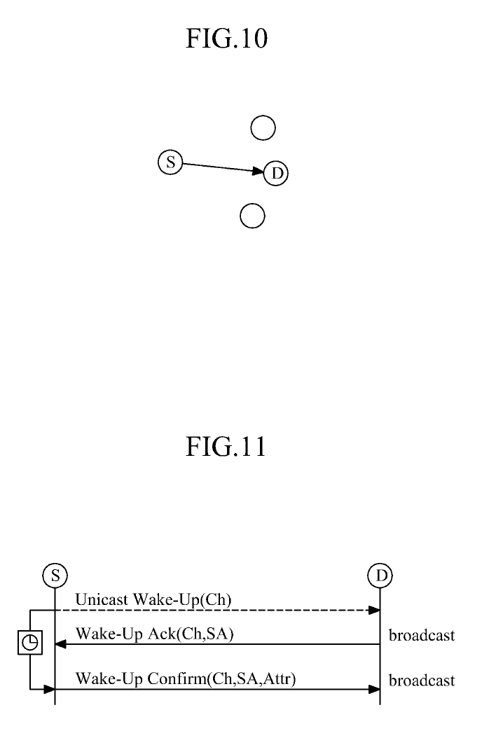

FIG. 10 is a view illustrating a Unicast Wake-Up in which a sending node wakes up a single sensor node, and FIG. 11 is a flowchart showing a process of the Unicast Wake-Up operation.

A sending node transmits a Unicast Wake-Up (Ch) packet to a nearby sensor node through a Wake-Up RF module, and sets a Unicast Wake-Up wait time. During the Unicast Wake-Up wait time, the sensor node, which has received the unicast Wake-Up (Ch) packet, transmits a Wake-Up Ack packet to the sending node. After the Unicast Wake-Up wait time has lapsed, the sending node, which has received the Wake-Up Ack packet, transmits a Wake-Up Confirm packet to the sensor node, which has received the Unicast Wake-Up (Ch) packet, thereby checking a Wake-Up state of the sensor node.

Hereinafter, the Wake-Up packet, the Wake-Up Ack Packet, the Wake-Up Confirm packet will be described.

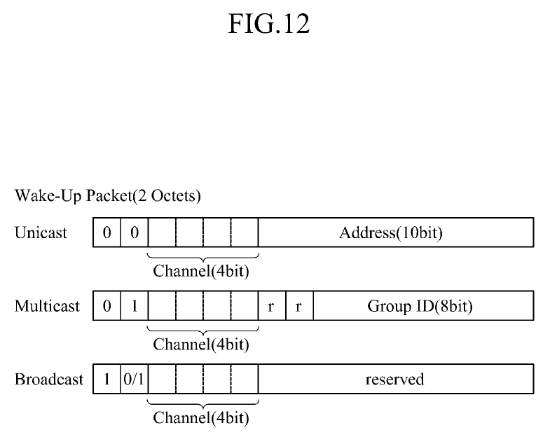

FIG. 12 is a view illustrating a Wake-Up Packet through which a sending node wakes up a receiving node.

A Wake-Up packet is classified into a Unicast packet, a Multicast packet and a Broadcast packet depending on a Wake-Up scheme. The first 2 bits of the Wake-Up packet are used for distinguishing a wake-up scheme. If the 2 bits have a value of ‘00’, ‘01’ and ‘1x’, the Wake-Up packet is regarded as a unicast packet, a Multicast packet and a Broadcast packet, respectively. The following 4 bits indicate a channel to be used by the sending node. In addition, the Unicast Wake-Up packet includes an address of the receiving node, and the Multicast Wake-Up packet includes a group ID, and a Broadcast Wake-Up packet does not include any address.

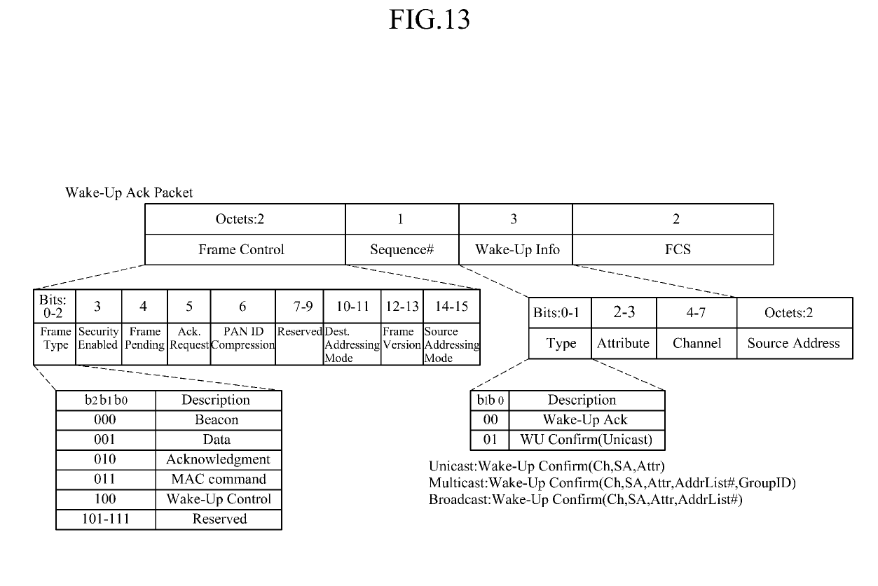

FIG. 13 is a view illustrating a Wake-Up Ack Packet used by a receiving node, which has received a Wake-Up Packet, to respond to a sending node.

For the purpose of a compatibility with a IEEE802.15.4 based packet, the Wake-Up Ack packet has a frame including a header of an IEEE802.15.4 Ack packet, and further includes Frame Control (2 octets), Sequence Number (1 octet), Wake-Up information (3 octets) and Frame Check Sum (FCS, 2 octets). Information regarding a frame type of the Frame Control used to distinguish a type of packets is represented by 3 bits. The frame type of ‘100’ represents a ‘Wake-Up Control’. The Wake-Up Info field includes Type (2 bits) of identifying a Wake-Up Ack packet, Attribute (2 bits, reserved), Channel (4 bits) sent from the sending node and Source address (2 octets) corresponding to a short address of the sending node.

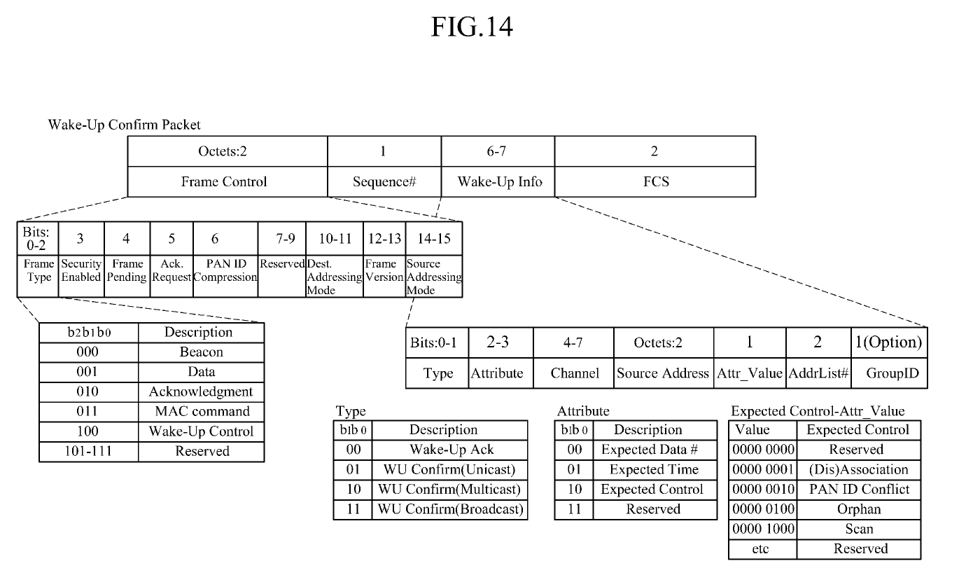

FIG. 14 is a view illustrating a Wake-Up Confirm Packet transmitted from a sending node, which has received a Wake-Up Ack Packet, to a receiving node.

For the purpose of a compatibility with IEEE802.15.4 packet, the Wake-Up Confirm packet has a header of an IEEE802.15.4 confirm packet, and further includes Frame control (2 octets), Sequence number (1 octet), Wake-Up information (3 octets) and Frame Check Sum (FCS, 2 octets). Information regarding a frame type of the Frame Control used to distinguish a type of packets is represented by 3 bits, and for example the frame type of ‘100’ represents a ‘Wake-Up control’.

The Wake-Up info field includes Type (2 bits) identifying a Wake-Up Confirm packet, and Attribute (2 bits, reserved) indicating a period during which an active state is maintained after the Wake-Up. The Attribute uses 2 bits. The Attribute of ‘00’ represents an Expected Data number corresponding to the number of data packets to be transmitted/received upon the Wake-Up before the sending node transits into a sleep state. The Attribute of ‘01’ represents Expected Time during which an active state is maintained after Wake-Up. The Attribute of ‘01’ represents Expected Control used to indicate the type of control messages generated after the Wake-Up. The Attribute of ‘11’ represents a ‘reserved’ state. Attr_Value (1 Octet) represents an actual value of the Attribute field. The Attr_Value corresponding to ‘Expected Data number’ is the number of data packets, and the Attr_Value corresponding to ‘Expected Time’ is the time during which the sending node maintains an active state. In the case that the Attribute is the Expected Control, the receiving node is woken up through a Multicast Wake-Up and a Broadcast Wake-Up after (Dis)Association, PANDID Conflict, Orphan, and Scan processes according to a setting of the Attr_Value. In addition, the Attr-Value is used to calculate the number of ‘Pick’ and report the number of nodes currently awake. Group ID field is used as a group ID in the Multicast Wake-Up.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other is implementations are within the scope of the following claims.

What is claimed is:

1. A method of transmitting data in a sensor node for constituting a sensor network, the method comprising:
transmitting a Wake-Up frame to at least one receiving node which is in an inactive state, thereby activating the receiving node; and
transmitting data to the activated receiving node.

2. The method of claim 1, wherein the transmitting of the Wake-Up frame is performed by a Wake-Up transceiver that is provided additionally in the sensor node including a main transceiver.

3. The method of claim 2, wherein, in the transmitting of the Wake-Up frame, the Wake-Up frame is transmitted by the Wake-Up transceiver through one of a broadcast scheme, a multicast scheme and a unicast scheme.

4. The method of claim 2, wherein the transmitting of the Wake-Up frame comprises:
supplying power to the Wake-Up transceiver which is in a power off state; and
transmitting the Wake-Up frame to the receiving node through the Wake-Up transceiver, to which power has been supplied.

5. The method of claim 2, wherein the transmitting of the wake-up frame to the receiving node comprises:
supplying power to the main transceiver which is in a power off state;
receiving a response packet in response to the Wake-Up packet from the receiving node through the main transceiver to which power has been supplied; and
transmitting the data to the receiving node, which has transmitted the response packet, through the main transceiver.

6. The method of claim 5, wherein the transmitting of the data to the receiving node further comprises transmitting a response confirmation packet to the receiving node which has transmitted the response packet; and wherein the transmitting of the data through the main transceiver is performed after the response confirmation packet is transmitted.

7. The method of claim 6, wherein the response confirmation packet contains information about an activation duration of the receiving node.

8. A method of receiving data transmitted from a sending node in a sensor node is constituting a sensor network, the method comprising:
transiting from an inactive state to an active state by receiving a Wake-Up frame transmitted from the sending node;
transmitting a response packet in response to the Wake-Up frame to the sending node after the transition into the active state; and
receiving data from the sending node which has received the response packet.

9. The method of claim 8, wherein the Wake-Up frame is received through a Wake-Up transceiver that is provided additionally in the sensor node including a main transceiver.

10. The method of claim 9, wherein the transition of the sensor node to the active state comprises:
when receiving the Wake-Up frame, at the Wake-Up transceiver, which operates in the inactive state, outputting a Wake-Up interrupt signal to a micro control unit, which operates in a sleep mode; and
at the micro-control unit, which has transited to an active mode by receiving the Wake-Up interrupt signal, supplying power to the main transceiver.

11. The method of claim 10, wherein the transiting of the sensor node into the active state further comprises cutting off power supplied to the Wake-Up transceiver.

12. The method of claim 10, wherein the response packet is transmitted through the main transceiver to which power has been supplied.

13. The method of claim 12, further comprising receiving, at the micro-control unit, a response confirmation packet from the sending node, which has received the response packet, wherein the receiving of the data is performed after reception of the response confirmation packet.

14. The method of claim 13, wherein the micro-control unit receives the response confirmation packet through the main transceiver.

15. The method of claim 13, wherein the micro-control unit checks information about an activation duration of the receiving node contained in the response confirmation packet and transits the sensor node into the inactive state after the activation duration elapses.

16. The method of claim 15, wherein the inactive state is a state in which the micro-control unit is in a sleep mode, the main transceiver is turned off and the Wake-Up transceiver is turned on.

17. A sensor node comprising:
a main transceiver to transmit/receive data;
a Wake-Up transceiver to transit a state of the sensor node; and
a micro-control unit, which transmits a Wake-Up frame to at least one receiving node through the Wake-Up transceiver such that the receiving node is activated from an inactive state into an active state, and transmits data to the activated receiving node through the main transceiver.

18. The sensor node of claim 17, wherein the micro-control unit configures a packet is containing information, which allows the activated receiving node to be inactivated after a predetermined time lapse.

19. The sensor node of claim 17, wherein, after receiving the Wake-Up frame transmitted from a sending node, the micro-control unit transits from an inactive state into an active state to supply power to the main transceiver, and receives data transmitted from the sending node through the main transceiver to which power is supplied.

20. The sensor node of claim 19, wherein the micro-control unit allows the sensor node to transit from the active state into an inactive state after a predetermined time lapse.
